(19) United States
(12) Patent Application Publication
(10) Pub. No.: US 2012/0227213 A1
(43) Pub. Date: Sep. 13, 2012

(54) POOL COVER COUPLING SYSTEMS

(76) Inventors: Toby Lee Karsten, Woodland Hills, UT (US); Darrell Kay Christensen, Orem, UT (US); Roman Richard Fisher, Provo, UT (US); Kevin Kendall Losee, Payson, UT (US); John Madison Patton, Lehi, UT (US)

(21) Appl. No.: 13/404,412

(22) Filed: Feb. 24, 2012

Related U.S. Application Data
(60) Provisional application No. 61/446,110, filed on Feb. 24, 2011.

(51) Int. Cl. E04H 4/14; E05D 15/14

(52) U.S. Cl. 16/87.2

(57) ABSTRACT

Coupling systems for use with pool and other covers for attaching one or more cords to deploy the cover over the pool or other structure with which it is used to translate a cover.

### RELATED APPLICATION DATA

This application claims priority to U.S. Provisional Application Ser. No. 61/446,110 filed Feb. 24, 2011, the contents of which is herein incorporated in its entirety by this reference.

### FIELD OF THE INVENTION

This invention relates to swimming pool covers, and in particular, to systems for coupling a pool cover to a cord used to translate the pool cover.

### BACKGROUND

Swimming pools may be provided with a pool cover made of fabric or a tarpaulin that prevents debris from falling into the pool, or that enhances water safety by keeping pets and children out of the pool. One existing pool cover translates on guide rails that are either built into the sidewalls of a pool or that are coupled to a deck that surrounds the pool. Such pool covers typically include a “leading edge bar” that is coupled to the pool cover fabric or tarpaulin. The leading edge bar may also be coupled at one or both ends to a “slider,” a device that fits within the guide rails. Finally, a rope or cord (generally referred to as a “cord”) may be provided to apply force to the slider and thereby translate the slider and leading edge bar within the guide rails, pulling the pool cover across the pool.

There are several known arrangements for coupling the leading edge bar, slider, cord, and fabric to one another. In one system, the cord is sewn onto an edge of the fabric that comprises the pool cover and the fabric may be bolted to the slider. Such coupling mechanisms provide minimal strength. For example, the system is only as strong as the stitches that secure the cord to the fabric. If the stitches break due to the force of translating the pool cover, then costly and time-consuming repairs are required. Such repairs may require removal of the entire pool cover to re-sew the cord onto the fabric. Such repairs often cannot be performed on-site, and the system must be transported to a factory or other location having a suitable sewing machine. Additional time is then required to re-install the pool cover on the pool.

In another system, the cord is fastened directly to the slider with mechanical fasteners such as screws or bolts (in other words, the cord is not sewn onto the fabric). Problems are also associated with this system, however. For instance, the fasteners puncture the cord, and thus, may cause the cord to split or fray. Additionally, the fasteners may eventually damage the guide rails as they come in contact with the guide rails and leave metal shavings in or around the pool when the slider material becomes aged and worn or may become corroded, causing weakness to the connection. In general then, known systems for use in pool covers are not satisfactory because such systems provide only minimal strength, and present difficulties in repairing or replacing parts when they break.

Thus, there is a need for stronger, more durable systems for use in pool covers.

There is additionally a need for systems for use in pool covers that are relatively easy and inexpensive to repair or replace.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

This invention includes a slider that translates on a guide rail coupled or mounted on pool or associated structures. The slider may be coupled to a leading edge bar and a pool cover, such that when the slider moves along or “translates” on the guide rail, the slider pulls the leading edge bar and pool cover across the pool. The slider translates on the guide rail in response to force applied to a cord, coupled, attached or otherwise connected to the slider. The cord may be coupled to the slider without being screwed or bolted to the slider, and without the cord being sewn directly to the cover. In one embodiment, for example, the cord may be provided with a tube or collar on one of its ends, and a portion of the slider may be provided with a shoulder that contacts the collar when the cord is pulled. Contact between the collar and the shoulder of the slider causes the slider to translate over or along the guide rail. In another embodiment the cord may be coupled to a tube or cylinder which is then secured to a tab using a bolt and nut, the tab then being secured to slider.

### BRIEF DESCRIPTION OF THE DRAWINGS

Illustrative embodiments of the present invention are described in detail below with reference to the following drawing figures:

FIG. 1 is an isometric view of a pool having a pool cover assembly of this invention

FIG. 2 is an enlarged view of “FIG. 2” circled portion of FIG. 1.

FIG. 3 is a cross-sectional view taken at line “FIG. 3” in FIG. 1.

FIG. 4 is an enlarged isometric view of one end of the pool cover assembly shown in FIG. 1.

FIGS. 5A and 5B are isometric and elevation views respectively of a slider and a cord of the pool cover of FIG. 1.

FIGS. 6A-C are top, isometric and end views of a slider of this invention. Portions of the slider in FIG. 6A are shown broken away to show underlying structure.

FIG. 7 is an isometric view showing the end of a leading edge bar of this invention.

FIG. 8 is somewhat schematized isometric view of a pool cover cord having a collar.

FIG. 9 is an exploded isometric view of a tab and cord assembly of this invention.

FIG. 10 is a partially exploded isometric view of a pool cover sub-assembly of this invention.

FIG. 11 is an isometric view of the pool cover sub-assembly of FIG. 10 shown assembled.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

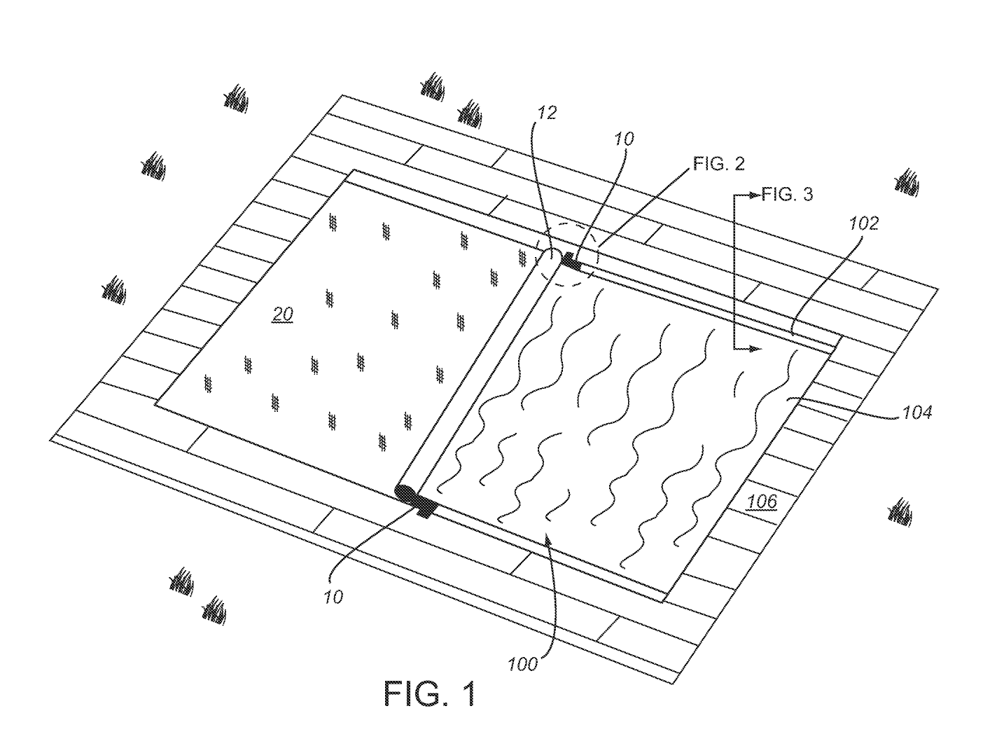

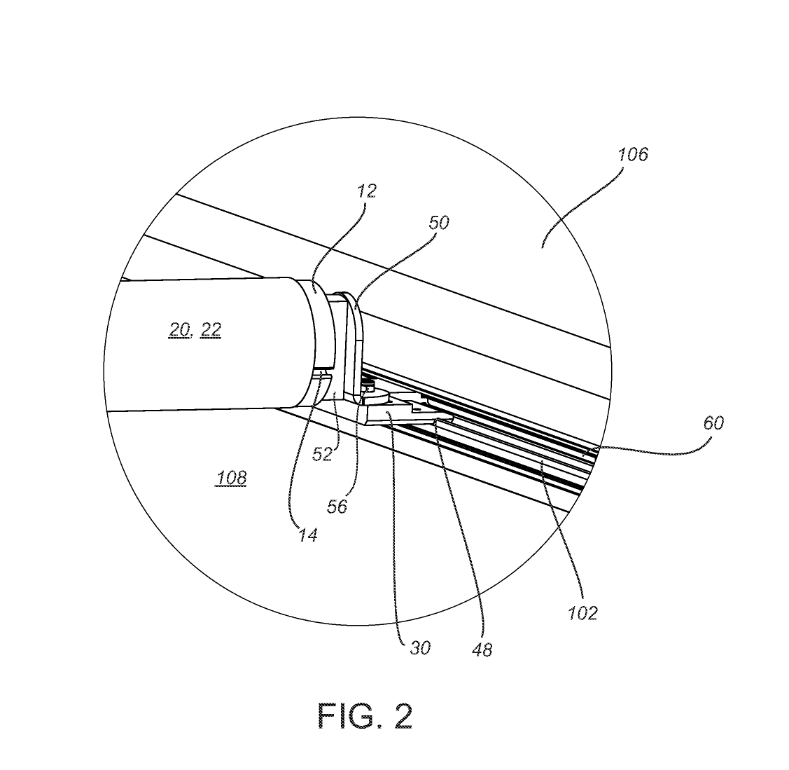

FIG. 1 illustrates a pool 100 filled with water 104 and fitted with a pool cover 20 opened or closed, or “translated”, across the pool 100 by at least one coupling assembly 10. The pool cover 20 may be composed of any suitable material, such as woven or other fabric, coated fabric, plastic, reinforced plastic, film and other materials. The pool 100 is defined by sidewalls 108 (one of which is shown in FIG. 2) and is surrounded by a deck 106. The systems of this invention may be used, however, with pools 100 having numerous configurations, including configurations not having decks 106. Additionally, although the embodiments described herein are for use with swimming pools, embodiments may also be used in other applications to translate a cover across a body. For example, the present invention may be used to translate a cover across the open bed of a pick-up truck or across a wide variety of other enclosed areas, buildings, pits, vessels, containers or the like such as a grain silo, vats of water and other liquids or other materials, storage vessels.

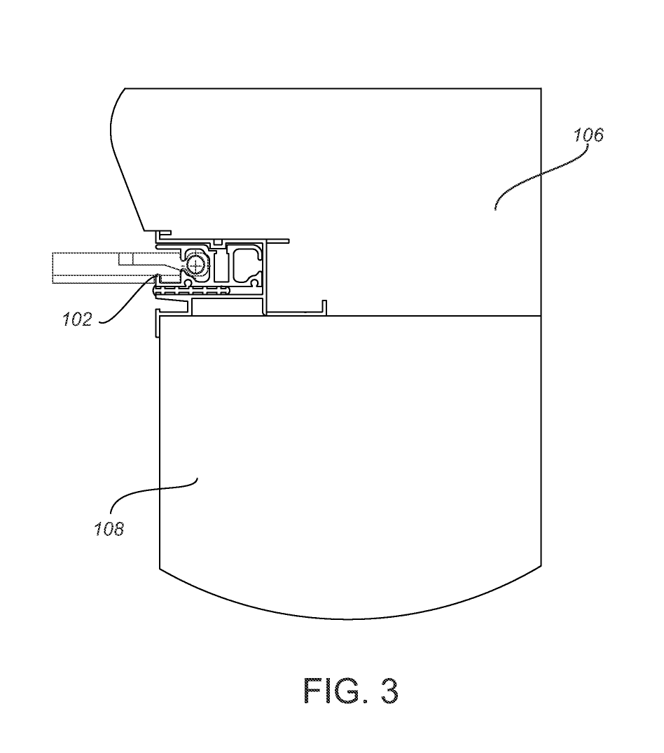

Two coupling assemblies 10 are positioned at opposite ends of a leading edge bar 12 coupled or attached to a pool cover fabric, tarpaulin or other sheet 20. In the illustrated embodiment, two guide rails 102 (shown in cross section in FIG. 3) are built into or otherwise positioned along opposite sidewalls 108 of the pool 100 (FIG. 3.) Guide rails 102 may include aluminum extrusions 110 or other structures that define a channel 112 open toward, and extending the length of, the pool 100. The two coupling assemblies 10 translate or slide along two guide rails 102 to pull the pool cover 20 across the pool. In other embodiments, the guide rails 102 may assume other shapes and may be coupled to the deck 106 or other surface or structure that surrounds the pool 100. Numerous configurations and locations for the guide rails 102 may be used to provide an appropriately configured and positioned guide along which the coupling assembly 10 may move. Additionally, although FIG. 1 shows two assemblies 10 on opposing sides of the pool 100, other embodiments may use only one assembly 10.

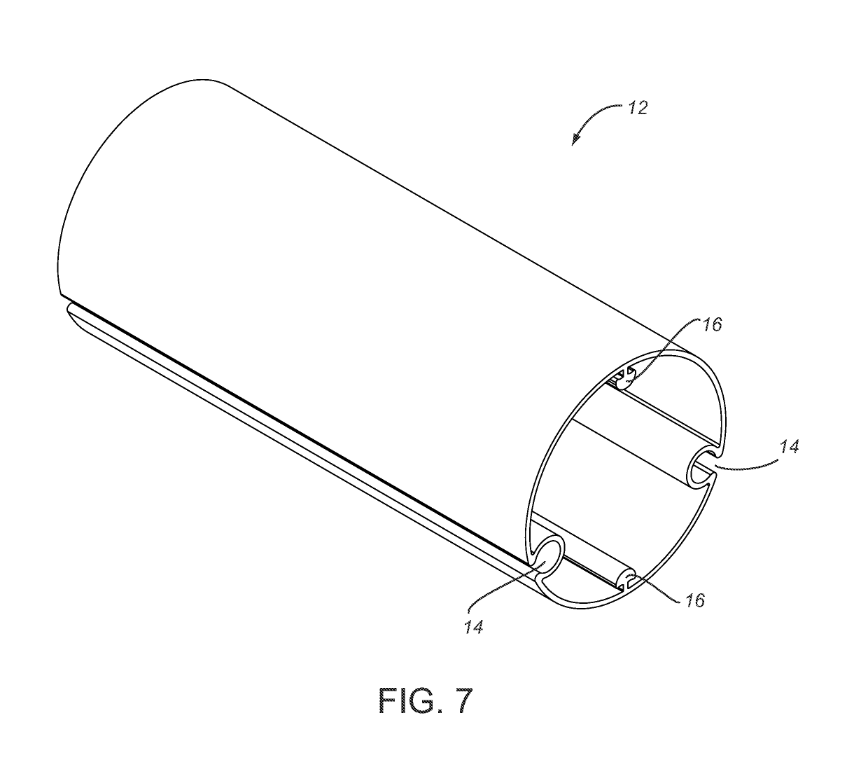

As is illustrated in FIG. 2, a coupling assembly 10 may include a slider 30 connected by a connecter 50 to a leading edge bar 12 that is attached or coupled to a pool cover 20. One embodiment of a leading edge bar 12 is shown in FIG. 7. In this embodiment, the leading edge bar 12 is an aluminum, composite, plastic, reinforced plastic or other extrusion having a wall 18 defining a generally circular cross section, and includes an opposing pair of crimps 14 that may have an omega-like shape opening outward and an opposing pair of inward-facing, mushroom-shaped protrusions 16 that extend within the leading edge bar 12.

As may be appreciated by reference to FIGS. 2, 7, 4, and 11, the protrusions 16 couple to an attachment block 52 or 252 secured to connector 50 or 250 by screws 54 or 254. Connector 50 or 250 is in turn coupled to the slider 30 or 220. The leading edge bar 12 may be comprised of any suitable material, including any metal or plastic and may be extruded, fabricated, machined molded or manufactured by any other suitable process using any suitable material(s). Finally, although the leading edge bar 12 is shown in the figures as being generally circular, any other appropriate shape (for example, square or octagon) may also be used.

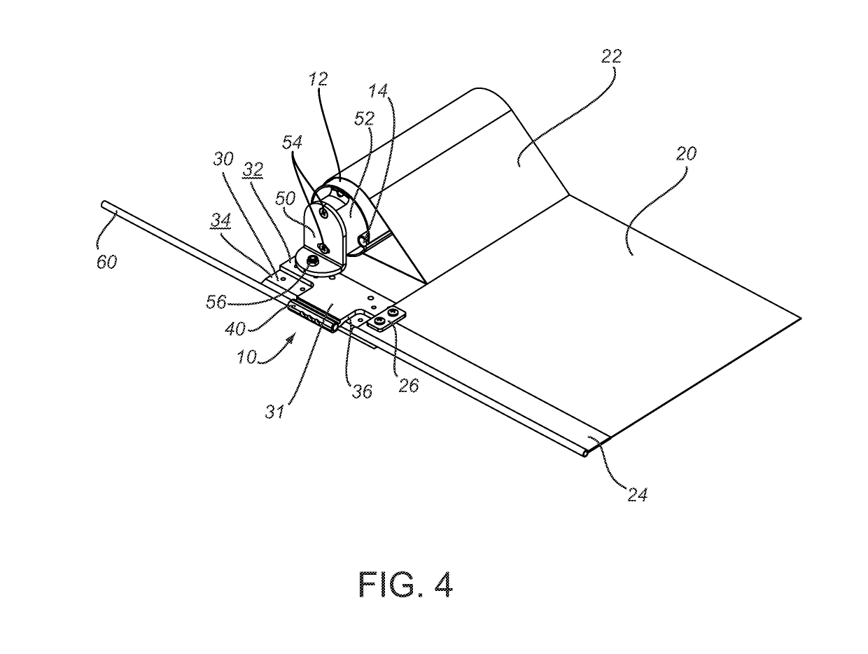

The leading edge bar 12 is coupled to the pool cover 20 and positions the leading edge of, and pulls, pool cover 20 across the pool 100. The pool cover 20 may be coupled to the leading edge bar 12 in a variety of ways. As shown in FIG. 4, a portion of the pool cover 20 may be formed into a loop 22 that slips over the leading edge bar 12. In this embodiment, the leading edge bar 12 is not visible, but is instead covered by the loop 22. In another embodiment, a cord (not shown) is attached across, or captured by, a front edge of the pool cover 20, which creates a “bead” along the front edge of the cover 20. One of the crimps 14 of the leading edge bar 12 may receives the “bead” of the cover 20, typically by sliding one end of the bead into a crimp 14 at one of the two ends of bar 12. In this embodiment, the leading edge bar 12 is exposed across the front edge of the pool cover 20.

Pool cover 20 need not necessarily be, but may be additionally fastened to the slider 30 to provide extra strength. Thus, as shown in FIG. 4 a mounting plate 26 and mechanical fasteners may be provided to couple the pool cover 20 to the slider 30.

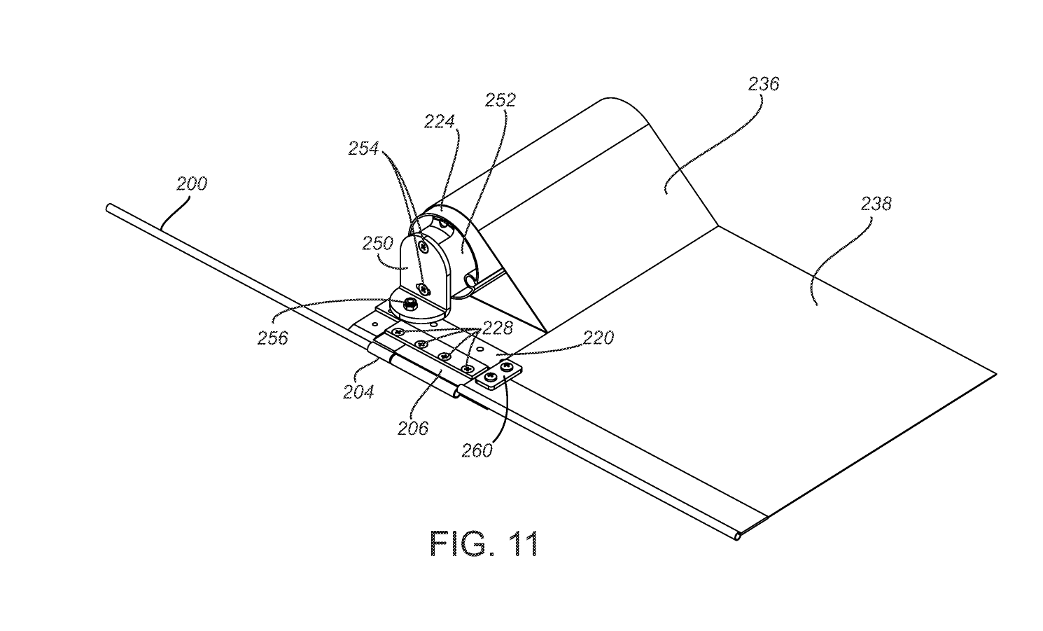

The leading edge bar 12 may be coupled to the slider 30 with a connector 50 having any suitable shape and/or configuration. As shown in FIG. 4, the connector 50 may be “L-shaped,” and may be coupled to both the leading edge bar 12 and the slider 30 with mechanical fasteners. For instance, connector 50 may be attached to slider 30 with a nut and bolt or other appropriate fastener 56 (visible in FIG. 2 and 4) or 256 (FIG. 11). Connector 50 may be attached to block 52 with screws 54 (FIG. 4), and connector 220 may be attached to block 252 with screws 254 (FIG. 11). Block 54 is configured to receive protrusions 16 in leading edge 12, thereby securing leading edge bar 12 to slider 30, and block 254 is configured to receive similar protrusions from leading edge bar 224, thereby securing leading edge 224 to slider 220.

In other embodiments, the connector 50 may be a planar sheet of material that is positioned on the diagonal between the slider 30 and the leading edge bar 12. In still other embodiments, there might not be a connector 50 at all. For example, the leading edge bar 12 may couple directly to structure on the slider 30 by means, for instance of an upwardly-extending projection from slider 30 that couples to the leading edge bar 12.

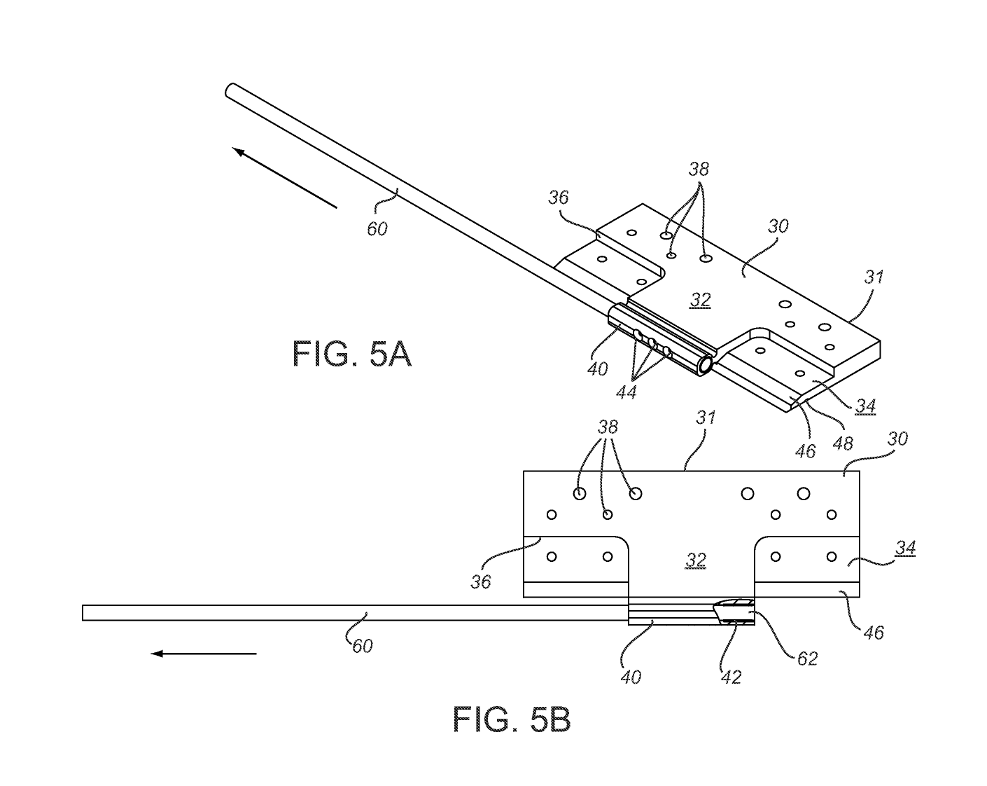

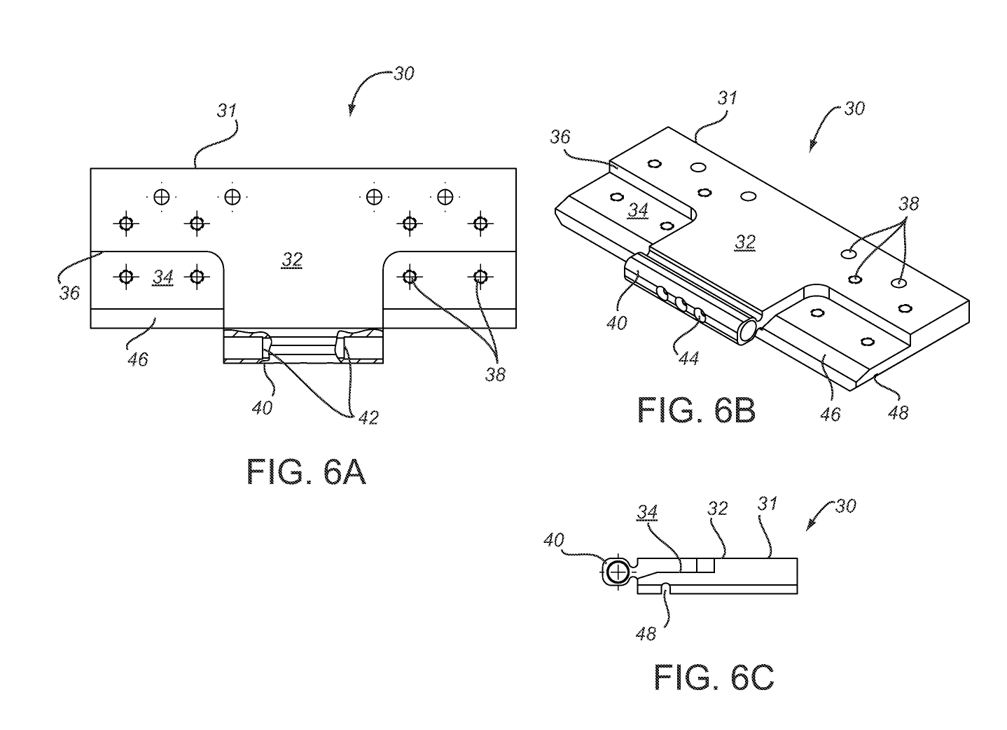

As shown in FIGS. 6A-C, the slider 30 may include a body 31 and a receiving portion 40 extending from the body 31 to receive a cord 60 (shown in FIGS. 5A and B). The body 31 may be penetrated by apertures 38 to receive mechanical fasteners that couple other components (such as the connector 50 or mounting plate 26) to the slider 30. If desired, the body 31 may be provided with a first surface 32 and a second surface 34 that is recessed below the first surface 32, creating a step 36. Such a recessed second surface 34 permits the pool cover material 20 and/or mounting plate 26 to lie flush with first surface 32 of body 31. The slider 30 shown in the figures is symmetrical such that there is a recessed second surface 34 on both ends of the slider 30. Thus, the same slider 30 can be used on one sidewall 108 of the pool 100, and then “flipped” to be used on the opposite sidewall 108. The recessed second surface 34 is not required, however, and in other embodiments, the body 31 of the slider 30 may have only first surface 32.

As shown in FIG. 6C, the slider 30 is provided with a recess 48 to fit within the guide rail 102 of a pool 100. FIG. 2 and FIG. 3 show how the recess 48 receives a portion of the guide rail 102. An opening in the guide rail 102 receives the receiving portion 40 and the cord 60. When force is applied to the cord 60, the recess 48 of the slider 30 translates over the guide rail 102. The edge 46 directly in front of the recess 48 may be beveled such that the slider 30 is easier to fit into the guide rail 102, and to make room for the receiving portion 40 and the cord 60.

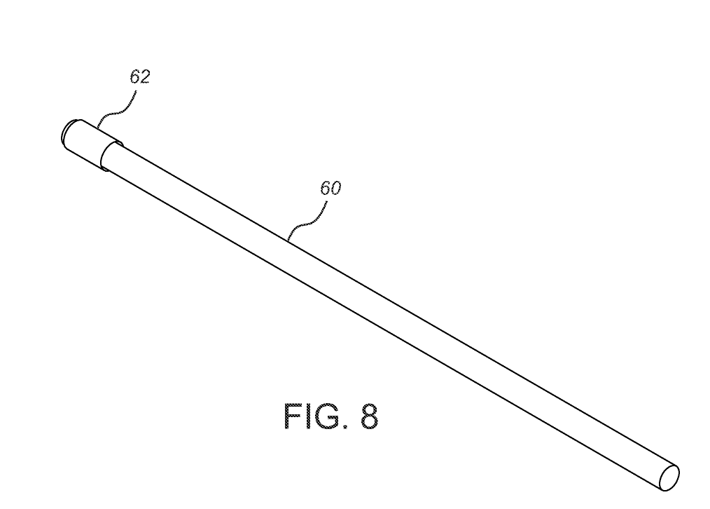

The receiving portion 40 of the slider 30 receives a an end of cord 60 that applies force to the slider 30 to slide it along guide rail 102, thereby likewise moving coupling assembly 10 together with the attached cover 20 components to deploy the cover on the pool or other structure with which it is used. As shown in FIG. 8, a collar 62 may be attached to cord 60, typically near one end of the cord. Cord 60 may be any elongated roll-able or coil-able structure suitable for pulling the cover 20 across the structure it covers. Cord 60 may be a twisted, woven, braided or otherwise configured rope, tape, strand, line, cable or the like made of any suitable natural or human-made material like nylon, polyethylene, aramid, liquid crystal polymer (LCP), polypropylene, cotton, sisal, hemp, steel, aluminum, glass or other material.

The collar 62, which prevents the end of cord 60 from pulling through receiver 40, thereby transferring force to receiver 40, may be any suitable metal, plastic or other suitable material and may be coupled to the cord 60 in a variety of ways that prevent detachment of the cord 60 from the collar 62. For example, the collar 62 may be crimped onto the end of the cord 60, may be glued with adhesives, may be molded onto the cord, may be riveted or pinned to the cord 60, and a protrusion from the collar 62 may pierce and retain the cord 60, among other alternatives. In some examples the cord 60 may be deformed or reshaped to couple with the collar 62, including for example, deforming the cord 60 by melting it or reshaping it by tying a knot at the end of the cord 60. The collar 62 engages with structure within the receiving portion 40 of the slider 30. In particular, and as shown in FIG. 6A, at least one end of the receiving portion 40 of the slider 30 may be counter-bored to create a shoulder 42. If desired, both ends may be provided with a shoulder 42 such that the same slider 30 may be used interchangeably on both sidewalls 108 of the pool 100. In other embodiments the collar 62 and receiving portion 40 of slider 30 may be coupled together by other means, including for example, an elongated fastener, a rivet, a pin, a screw, or other mechanical fastener.

As shown in FIG. 5B, when a force is applied to the cord 60 in the direction of the arrow, the collar 62 contacts the shoulder 42, thus applying a force to the slider 30 in the direction of the arrow. If desired, the receiving portion 40 may additionally be provided with apertures 44 to receive mechanical fasteners such as pins, screws or rivets (not shown) passing through cord 60 to further secure the cord 60 within the receiving portion 40.

Thus, the coupling assemblies 10 provide strengthened components and component connections or coupling to provide more durable, functional, versatile and attractive covers. Fasteners are not needed to couple the cord 60 to the slider 30, which prevents damage to the guide rails 102 and prevents metal shavings from landing in the pool 100 or on the deck 106, which can be harmful to walk on. Likewise, it is not necessary to sew the cord 60 onto the pool cover 20. If the collar 62 happens to detach from the cord 60 or cord 60, it is relatively easy to simply attach a new collar 62 or replace cord 60 without completely removing the pool cover 20. Thus, unlike some existing systems, it is not necessary to completely remove the pool cover 20 in order to repair broken components.

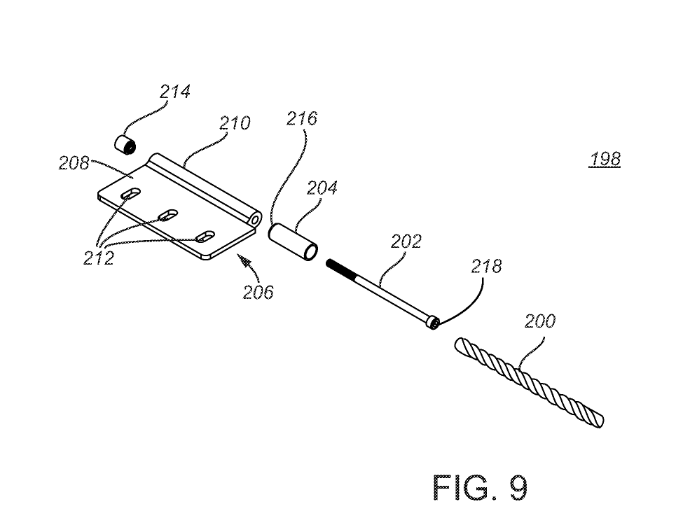

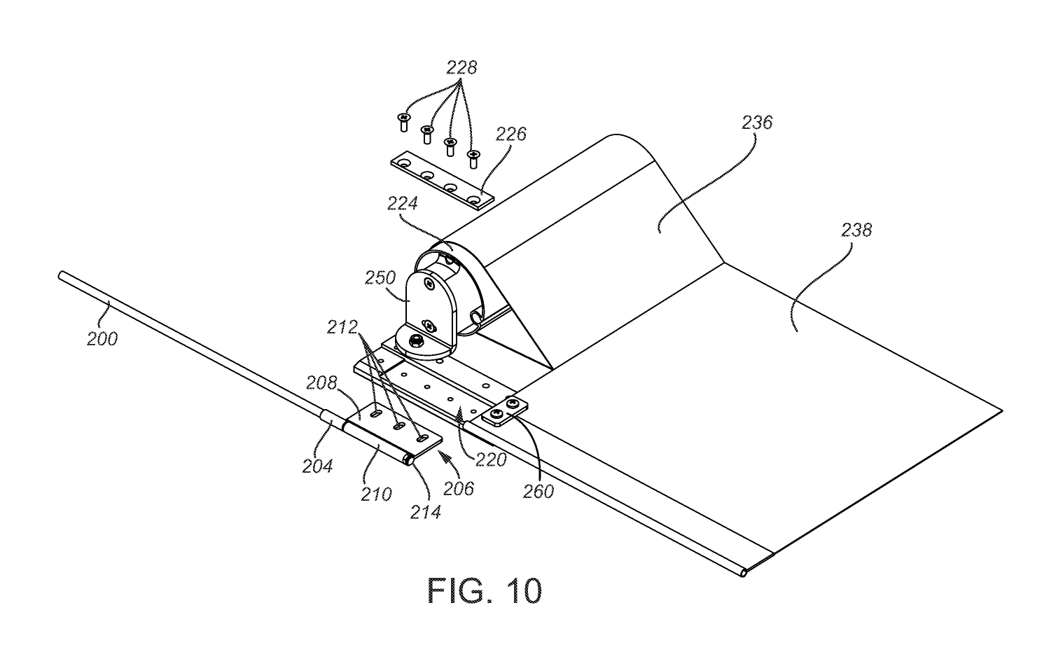

As shown in FIG. 9, in another embodiment of the invention, a tab and cord assembly 198 may be secured to a slider 220 (as shown in FIGS. 10-11). A tab 206 may include a planar body 208 and a receiving portion 210 extending along one edge of body 208 to attach a cord 200 (shown in FIGS. 9-11). A Bolt 202 passes through a tub or cylinder 204, which has an internal diameter large enough to receive the head 218 of bolt 202, but the end 216 of cylinder 204 proximate receiving portion 210 has a smaller opening through which bolt head 218 cannot pass. Bolt 202 is positioned within receiver 210, and is secured with nut 214, thereby securing cylinder 204 to tab 206. Cord 200 is received and secured within cylinder 204 to enable cord 200 to apply force to tab 206. For example, as similarly described above, the cylinder 204 may be crimped onto the end of the cord 200, may be glued with adhesives, may be molded onto the cord, may be riveted or pinned to the cord 200, and a protrusion from the collar 62 may pierce and retain the cord 60, among other alternatives. In some examples the cord 200 may be deformed or reshaped to couple with the cylinder 204, including for example, deforming the cord 200 by melting it or reshaping it by tying a knot at the end of the cord 200. The cylinder 204 may be coupled to tab 206 by means other than a bolt and a nut. For example, an elongated fastener, a rivet, a pin, a screw, or other mechanical fastener. With tab 206 connected to the slider 220 (as shown in FIGS. 10 and 11), this force exerted by cord 200 slides or translates slider 220 along a guide rail. An end of cord 200 may be received and secured in cylinder 204 by crimping the cylinder 204 around the cord 200. Alternative attachment schemes may also be sued such as adhesive or cross pins.

The tab 206 may include apertures 212 to receive screws, bolts, pins or other mechanical fasteners that couple the tab 206 to the slider 220 (as shown in FIG. 10 and FIG. 11). Tab 206 may be symmetrical such that the same tab 206 can be used on one sidewall of the pool, and then “flipped” to be used on the opposite sidewall (see FIGS. 9-11).

If bolt 202 does not secure cylinder 204 against receiving portion 210 to prevent it from rotating, cylinder 204 can rotate freely in relation to the receiving portion 210 and tab 206. This capability for free rotation between the cord 200 and the tab 206 reduces the chances that a jacket around cord 200 bunch or become damaged due to twisting. In some embodiments a swivel may be used to allow for rotation between the cord 200 and the tab 206. In addition, by coupling the cord 200 to the tab 206 instead of directly to the slider, 220 repairs to the components of the tab and cord assembly 198 may be made without having to remove all the components that the slider 220 is attached to.

The leading edge bar 224 may be coupled to the slider 220 with a connector 222. Any suitable shape and/or configuration may be used for the connector 222. As shown in FIGS. 10 and 11, the connector 222 is “L-shaped,” and is coupled to both the leading edge bar 224 and the slider 220 with mechanical fasteners 254 and 256. The connector 222 may be a planar sheet of material that is positioned on the diagonal between the slider 220 and the leading edge bar 224. In still other embodiments, there might not be a connector 222 at all. For example, the leading edge bar 224 may couple directly to structure on the slider 220. In one such embodiment the slider 220 includes an upwardly-extending projection that couples to the leading edge bar 224.

Tab 206 is coupled to the slider 220 with mechanical fasteners 228 through the tab 206 apertures 212 and securing plate 226 apertures 230. In yet another embodiment, the tab 206 and slider 220 may be coupled by other means, including wiring, gluing or attaching with other adhesives, or welding the tab 206 to the slider 220. The pool cover 238 may be coupled to the leading edge bar 224 by a loop 236 of pool cover within which the leading edge bar 224 is positioned. Pool cover 238 need not necessarily be, but may be additionally fastened to the slider 220 to provide extra strength. Thus, as shown in FIGS. 10 and 11 a mounting plate 260 and mechanical fasteners may be provided to couple the pool cover 238 to the slider 220.

The foregoing is provided for purposes of illustration and disclosure of embodiments of the invention. It will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art. Different arrangements of the components depicted in the drawings or described above, as well as components and steps not shown or described are possible. Similarly, some features and subcombinations are useful and may be employed without reference to other features and subcombinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

That which is claimed is:

1. A coupling system for a cover comprising:
a leading edge bar coupled to a cover material, the leading edge bar having two ends;
two sliders, one of which is connected to each of the two leading edge bar ends and each slider having a recess for engaging with a guide rail having a track;
a tube cord termination coupled to one of the sliders and to the end of a cord.

2. The system of claim 1, wherein the tube cord termination is coupled to the end of the cord by crimping the tube cord termination onto the cord.

3. The system of claim 1 further comprising a protrusion mechanism, wherein the end of the cord is coupled to the tube cord termination by the protrusion mechanism passing through the tube cord termination and into the end of the cord.

4. The system of claim 3, wherein the protrusion mechanism is a spike or bent piece of metal.

5. The system of claim 1, wherein the tube cord termination is coupled to the end of the cord by passing the end of the cord through a first end of the tube cord termination and deforming the end of the cord at a second end of the tube cord termination.

6. The system of claim 5, wherein deforming the end of the cord comprising melting or knotting the end of the cord.

7. The system of claim 1, wherein the tube cord termination is coupled to the slider by the tube cord termination passing through an opening in the slider defined by a shoulder, the tube cord termination contacting and engaging with the shoulder when tension is applied to the cord.

8. The system of claim 1, wherein the tube cord termination is coupled to a tab which is secured to the slider.

9. The system of claim 1, wherein the tube cord termination is coupled to the slider by a mechanical fastener selected from the group comprising: a bolt and a nut, a rivet, a screw, or a pin.

10. A coupling system for a pool cover comprising:
a leading edge bar coupled to a pool cover material, the leading edge bar having two ends;
a first and second slider, one of which is connected to each of the two leading edge bar ends,
each slider comprising:
a body,
a recess for engaging with a guide rail having a track, and
an opening defined by a shoulder;
a tube cord termination coupled to the first slider and to the end of a cord;
wherein the tube cord termination is coupled to the first slider by the tube cord termination passing through the opening of the first slider, the tube cord termination contacting and engaging with the shoulder when tension is applied to the cord.

11. The system of claim 10, wherein the tube cord termination is coupled to the end of the cord by crimping the tube cord termination onto the cord.

12. The system of claim 10, further comprising a protrusion mechanism, wherein the tube cord termination is coupled to the end of the cord by the protrusion mechanism piercing both the tube cord termination and the end of the cord.

13. The system of claim 12, wherein the protrusion mechanism is a spike or bent piece of metal.

14. The system of claim 10, wherein the tube cord termination is coupled to the end of the cord by passing the end of the cord through a first end of the tube cord termination and melting the end of the cord at a second end of the tube cord termination.

15. The system of claim 10, wherein the tube cord termination is coupled to the end of the cord by molding the tube cord termination onto the end of the cord.

16. The system of claim 10, wherein the slider comprising a body further comprising a first surface and a second surface that is recessed from the first surface.

17. The system of claim 10, wherein the cord comprises rope or cable.

18. The system of claim 10, wherein the tube cord termination comprises metal or plastic.

19. The system of claim 10, wherein one of each of the two sliders is secured to each of the two ends of the leading edge bar by a connector and one or more fasteners.

20. A coupling system for a pool cover comprising:
a leading edge bar coupled to a pool cover material, the leading edge bar having two ends;
a slider connected to one of the two leading edge bar ends;
a tab secured to the slider, the tab comprising:
a body,
a recess for engaging with a guide railing having a track, and
a tube penetrated by a bore hole;
a tube cord termination coupled to the tab and to the end of a cord.

21. The system of claim 20, wherein the tube cord termination is coupled to the end of the cord by crimping the tube cord termination onto the end of the cord.

22. The system of claim 20, wherein the tube cord termination is coupled to the end of the cord by molding the tab over and onto the end of the cord.

23. The system of claim 20, wherein the cord comprises rope or cable.

24. The system of claim 20 wherein the tube cord termination is coupled to the tab by an elongated fastener passing through the tube cord termination and the bore hole.

25. The system of claim 24 wherein the elongated fastener comprises a rivet or a bolt.
